(19) United States
(12) Patent Application Publication
(10) Pub. No.: US 2017/0024717 A1
(43) Pub. Date: Jan. 26, 2017

(54) Microapplications Software Marketplace for Digital Systems and Method of Use

(71) Applicant: Mitoc Group Inc., Woodcliff Lake, NJ (US)

(72) Inventor: Eugeniu Istrati, Glen Rock, NJ (US)

(73) Assignee: Mitoc Group Inc., Woodcliff Lake, NJ (US)

(21) Appl. No.: 15/215,902

(22) Filed: Jul. 21, 2016

Related U.S. Application Data
(60) Provisional application No. 62/195,190, filed on Jul. 21, 2015.

(51) Int. Cl. G06Q 20/12; G06Q 30/06; H04L 29/08

(52) U.S. Cl. CPC G06Q 20/123; H04L 67/16; H04L 67/306; G06Q 30/0641

(57) ABSTRACT

Disclosed is a system and method for provisioning and deploying digital systems using microapplications running natively and securely on top of cloud computing providers. The system includes a software marketplace that allows users to purchase microapplications on a subscription basis in order to build, deploy, and manage the microapplications as a custom digital system in their accounts from the cloud-computing providers.

### CROSS-REFERENCE TO RELATED APPLICATIONS

This application claims the benefit of U.S. Provisional Patent Application No. 62/195,190, filed Jul. 21, 2015, which is hereby incorporated by reference in its entirety.

### FIELD OF THE INVENTION

The present invention generally relates to cloud computing services. More particularly, the present invention is directed to a software marketplace for microapplications that can be deployed as a custom digital system in a user's account from cloud computing providers.

### BACKGROUND OF THE INVENTION

With the rapid advancement of technology, many organizations require faster and easier management and security of their digital systems. While various types of digital systems exist, these systems generally need access to underlying operating systems or servers to run properly. Alternatively, digital systems that do not require above-mentioned capabilities can be complicated and expensive to run at scale. Thus, existing digital systems are expensive and difficult to operate at scale, which can potentially make these digital systems vulnerable.

Therefore, there is a need in the prior art for a digital system that can be provisioned and deployed without access to the underlying infrastructure and that can provide easier and less expensive solutions to interact between a digital system and a digital user or a digital system and other systems in a centralized location. In this regard, the invention described herein addresses these problems.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments of the present method include provisioning and deploying digital systems using microapplications running natively and securely on top of cloud computing providers.

Some embodiments of the present system comprise a software marketplace that allows users to select microapplications, add them to a shopping cart and deploy them as a custom digital system in their accounts from cloud computing providers.

Some embodiments of the present system comprise a digital system implemented with a front end code that is deployed and executed on a managed hosting service and that is distributed globally through managed content delivery network, and a back end code that is deployed and executed on a managed computing service and optionally proxied through managed API gateway service, and a database that is a managed relational database service or a managed schema-less database service, wherein managed services (also referred to as abstracted services as used herein) are offered by cloud computing providers.

Some embodiments of the present system include a digital enterprise end-to-end platform (DEEP) that is powered by managed services from cloud computing providers such as, but not limited to, Amazon Web Services® (AWS®). DEEP is an ecosystem of DEEP Framework—full-stack JavaScript® framework for building cloud-native web applications; DEEP Command Line Interface (CLI or “Deepify”)—software development tool-chain that abstracts package management and associated development operations; and DEEP Marketplace—microapplications software marketplace for digital systems.

In particular, DEEP Marketplace allows customers to choose the technical functionality that better suit their business use cases. Users, especially non-technical ones, can load in their browser DEEP Marketplace, add to shopping cart specific microapplications that matches their business needs, provide their billing information and access credentials to their cloud computing provider account, and subscribe to use the software. The system is configured to validate the users' billing information and access credentials to their cloud computing provider account, and then combine all selected microapplications, compile and build every tier (front-end, back-end, data and security) in the final custom digital system, provision required cloud computing services, package software with customized parameter values, and deploy corresponding software on each cloud computing service. The entire process is fully transparent and automated, allowing non-technical users to avoid dealing with technical issues and focus only on their business needs.

It is therefore an object of the present invention to provide a system that allows users to build, deploy, and manage customizable digital systems without dealing with technical issues such as infrastructure provisioning, platform customization, performance degradation, security exposure, or exponential growth in cost at scale in an efficient and a convenient manner.

It is another object of the present invention to provide a system that allows users to run their digital systems in their own accounts from cloud computing providers.

It is still another object of the present invention to provide a system that allows users to customize digital systems workflows using smaller components called microapplications.

It is still another object of the present invention to provide a system that allows users to build digital systems or platforms that are managed in a centralized location.

It is still another object of the present invention to provide a system in a platform as a service mode that enables users to manage their custom digital systems without dealing with technical components.

It is still yet another object of the present invention to provide a system that is designed as a microservices architecture on top of a cloud-computing infrastructure.

In the light of the foregoing, these and other objectives are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 shows exemplary platform architecture of the present system.

FIG. 2 shows another exemplary platform architecture of the present

FIG. 3 shows an exemplary graphic user interface of DEEP marketplace of the present invention.

FIG. 4 shows exemplary method steps of the present invention in operation.

FIG. 5 shows an exemplary flowchart of building scalable web apps with a computing service of a cloud provider.

FIG. 6 is a block diagram of a machine in the example form of a computer system within which a set of instructions, for causing the machine to perform any one or more of the methods discussed herein, may be executed.

### DETAILED DESCRIPTION OF THE INVENTION

The present invention is directed towards a system and method for creating and managing digital assets or content using serverless architecture. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a personal computer (PC), a desktop computer, a mobile computer, a laptop, a tablet computer, a server computer, a handheld device, a personal digital assistant (PDA), a wireless communication device, a smart phone, a non-portable device, a wireless access point (AP), a wired or wireless router, a wired or wireless modem, a wired or wireless network, a local area network (LAN), a wireless LAN (WLAN), the Internet, a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or the like.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form.

As used in this application, the term “digital platform” means a system that allows users or computers to interact with it, in order to obtain digital assets, goods, or services. The term “digital assets” means images, videos, websites, mobile applications, micro sites, blogs, and the like. The term “managed services” means the practice of outsourcing day-to-day management responsibility and functions as a strategic method for improving operations and cutting expenses.

The term “cloud computing” means the practice of transitioning computer services such as computation or data storage to multiple redundant offsite locations available on the Internet, which allows application software to be operated using Internet-enabled devices. The term “microservices” means a software architecture style, in which complex applications are composed of small, independent processes communicating with each other using language-agnostic APIs. These services are small, highly decoupled and focus on doing a small task.

Additionally, as used herein, the terms “web service(s),” “cloud provider(s),” “cloud computing service(s),” “managed service(s),” and “abstracted service(s)” are used interchangeably unless the context clearly suggests otherwise. Similarly, as used herein, the terms “user(s),” “customer(s),” “client(s),” and “developer(s)” can be used interchangeably unless the context clearly suggests otherwise.

According to example embodiments of the present disclosure, the web services of the present system may include, for example, AWS®, Amazon® AppStream, API Gateway, AWS® Config, CloudFront, CloudFront Distribution, CloudFront Logs, CloudSearch, CloudWatch, Cognito Identity, Cognito Sync, DevPay, DynamoDB, Direct Communication, Elastic Map Reduce, Elastic Transcoder, ElastiCache, Elastic Compute Cloud (EC2), Federation, Glacier, Kinesis, Lambda, Mechanical Turk, Mobile Analytics, Redshift, Relational Database Service, Route 53, Simple Email Service, SimpleDB, Simple Notification Service, Simple Queue Service, Simple Storage Service (S3), Simple Workflow Service, VPC, Auto Scaling, and Work Spaces. Additional examples may include AWS® CloudTrail, CloudFormation, Data Pipeline, Direct Connect, Elastic Beanstalk, Identity and Access Management (IAM), Storage Gateway, Support, Elastic Load Balancing (ELB), Elastic Block Store (EBS) Ops Work, Elasticsearch Logstash Kibana (ELK), and additional services. In other embodiments, other compatible cloud providers and web services such as Google® Cloud Platform or Microsoft® Azure may be used.

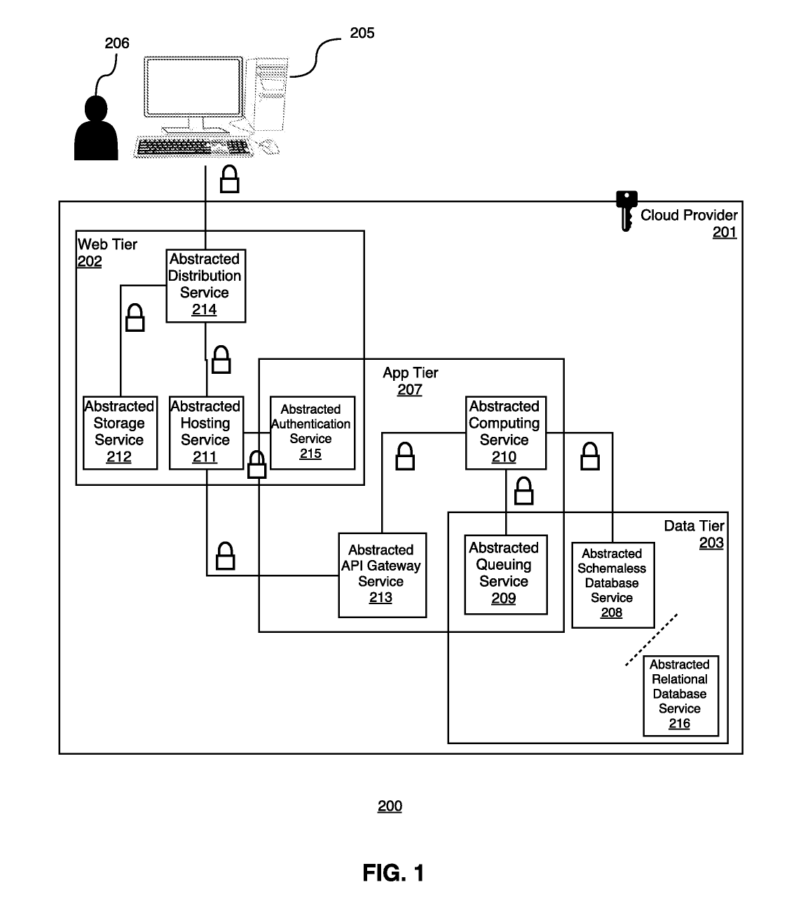

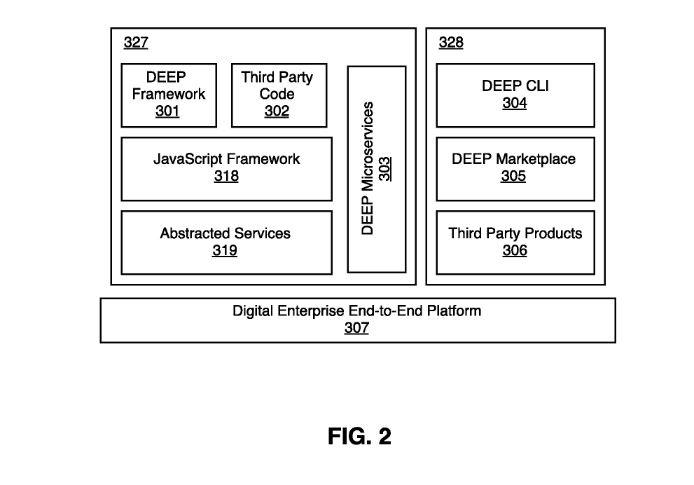

Referring now to FIGS. 1 and 2, there are shown various views of platform architecture of the present invention. The system 200 comprises a user device 205 that is operated by a user 206, wherein the user device 205 comprises various types of computer systems such as a desktop, a laptop, a mobile phone, a personal digital assistant (PDA), a tablet computer, and the like. The device is in communication with a cloud provider 201 or cloud computing services for example, via the Internet or other types of network described herein.

In the illustrated embodiments, the cloud provider 201 preferably provides managed services to manage a front end tier 202, a data tier 203, and an application tier 207 or a back end tier. The front end tier 202 services include an abstracted hosting service 211 in connection with an abstracted distribution service 214 for content delivery, and an abstracted authentication service 215 for user identity and app data synchronization. Additionally, the abstracted distribution service 214 is connected to an abstracted storage service 212, which is configured to log files that contain information about every user request that the abstracted distribution service 214 receives via the user device 205. In some embodiments, a user can specify which files to store in the abstracted storage service 212.

The data tier 203 services include an abstracted schemaless database service 208 and an abstracted relational database service 216, wherein the abstracted schemaless database service 208 preferably comprises NoSQL database service. In other embodiments, the abstracted schemaless database service 208 comprises a fully managed petabyte-scale data warehouse, depending upon embodiment.

The application tier 207 services include an abstracted API gateway service 213 to facilitate creating, publishing, maintaining, monitoring, and securing APIs at any scale, the abstracted authentication service 215 to save mobile user data without writing any back end code or managing any infrastructure, an abstracted computing service 210, wherein the abstracted computing service 210 is used to run code in response to events without provisioning or managing servers, and an abstracted queuing service 209 for transmitting any volume of data at any level of throughput. The abstracted API gateway service 213 is in connection with the abstracted hosting service 211 and the abstracted computing service 210. The abstracted computing service 210 is further connected to the abstracted queuing service 209 and the abstracted schemaless database service 208.

The present system further comprises DEEP platform 307, which is powered by abstracted API gateway services 213 from cloud computing providers 201. DEEP platform 307 comprises a platform-as-a-service (PAAS) 327 that includes DEEP microservices 303, DEEP framework 301, third party code 302, JavaScript® framework 318, and abstracted services 319 (e.g., AWS®). DEEP microservices 303 combines code to manage software and hardware in the same place. A collection of the microservices and related developer tools comprise the framework, wherein the framework allows the present system to exist as a single platform.

DEEP framework 301 is a full-stack JavaScript® framework for building cloud-native web applications or digital systems. It abstracts web applications and web services from specific cloud providers. DEEP framework 301 comprises a collection of JavaScript® libraries that can be used either in front end or back end, depending upon embodiment. Every library abstracts certain component of a web application or a cloud provider service. Under DEEP framework 301, developers get out-of-the-box: streamlined development environment; enterprise-level platform using microservices architecture; virtually infinite scalability with zero devops (i.e., serverless computing); and abstracted use of web services from various cloud providers

DEEP CLI 304 or Deepify is a software development tool-chain that abstracts package management and associated development operations.

Production pipeline in context of DEEP framework 301 and DEEP CLI 304 is focused on developers and makes it easier for them to build, test, and deploy serverless applications. DEEP CLI 304 server simulates the entire stack on local host and helps developers build and test their microservices/microapplications without any need of cloud provider accounts (e.g., AWS® accounts). DEEP CLI 304 deploys the microservices/microapplications on a cloud provider account, into a specific environment (e.g., production, stage, test, develop, etc.).

The present system further comprises software-as-a-service 328, which include DEEP CLI 304, DEEP marketplace 305, and third party products 306. DEEP marketplace 305 comprises microapplications software marketplace for digital systems. DEEP marketplace 305 comprises a GUI to commercialize value-added microservices. The GUI of the present system may be implemented using any suitable hardware components and/or software components, for example, processors, controllers, memory units, storage units, input units, output units, communication units, operating systems, and applications. In some embodiments, the GUI may include, or may be part of a web-based application, a website, a webpage, a standalone application, a plug-in, a rich content component, or the like.

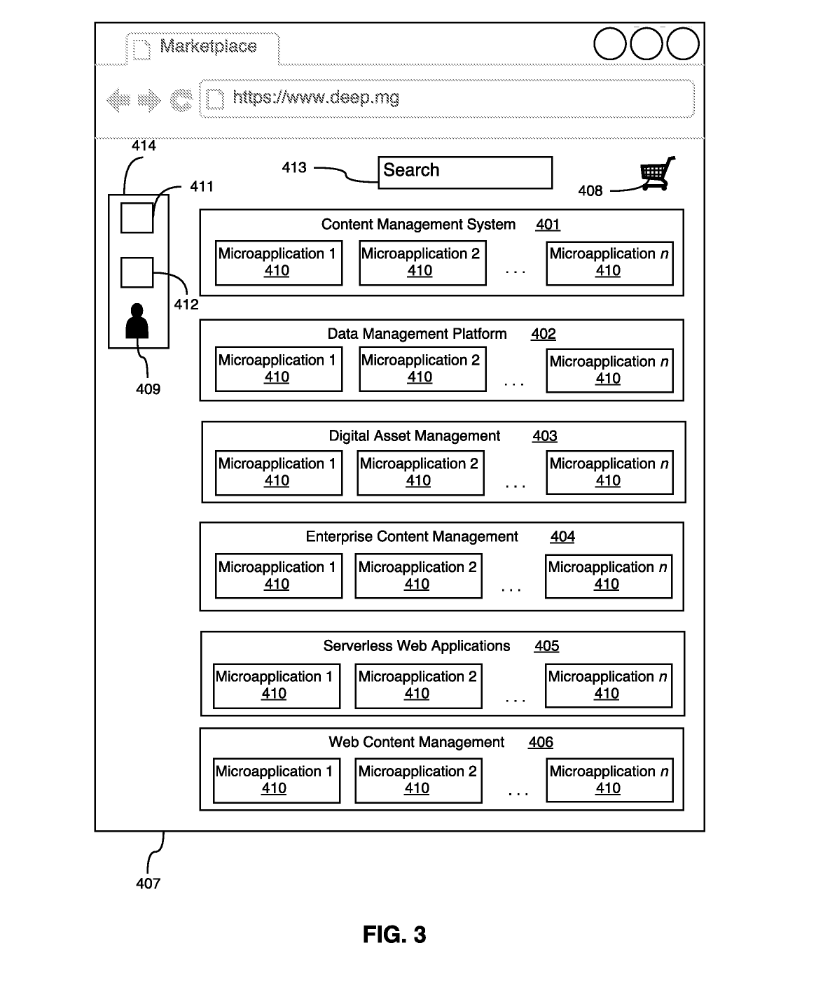

Referring now to FIG. 3, there is shown an exemplary GUI 407 for DEEP marketplace 305 (FIG. 2), which is powered by DEEP framework 301 (FIG. 2). DEEP marketplace 305 is a public microapplication store built on top of DEEP framework 301 (FIG. 2) that enables customers to choose functionality from listed microservices/microapplications 410 and deploy them together as a web app into their own cloud provider accounts. DEEP marketplace 305 also allows developers to create and publish their microservices/microapplications 410 and monetize them.

In the illustrated embodiment, DEEP marketplace 305 comprises a content management system 401, a data management platform 402, a digital asset management service 403, an enterprise content management service 404, serverless web applications 405, and web content management service 406, each comprising one or more microapplications 410 having different functionality, wherein the microapplications 410 can be purchased for subscription and/or on a one-time basis.

The GUI 407 of DEEP marketplace 305 further comprises a menu 414 comprising a microapplications button 411, a subscriptions button 412, and an account button 409, wherein the foregoing buttons can be used to navigate within DEEP marketplace 305. For example, a customer can select the microapplications button 411 to view a list of the published microservices/microapplications 410. Additionally, the customer can select the subscription button 412 to access the microservices/microapplications 410 that he or she has subscribed.

Finally, the account button 409 can be used to access customer accounts, whereby activating the account button 409 prompts the customer to sign in to the customer's cloud provider account. If there is no existing account, customers can create and then log onto their account. Each of the customer account is associated with information relating to a customer, for example, account information, billing information, activity log, access credentials, and the like, further wherein the account information is stored in a database.

Once logged on, the customer can populate his or her digital assets. In this regard, the customer can either upload the digital assets in a file or create a new asset by providing general information and source origin. The origin source may be a source code repository such as Git, a crawling source similar to a search engine, or the like. Other sources of assets include GitHub, or Subversion, or internal infrastructure. Thereafter, the customer can view each of the digital assets and the environments associated therewith.

Customers can search for a specific functionality in the GUI 407 of DEEP marketplace 305 and deploy the microapplication 410 in their own cloud provider accounts as a web application. More specifically, customers can conduct a search, for example, via a search box 413, and select one or more microservices/microapplications 410 from a list of results comprising wanted functionality (or compatible functionalities) and add it to the shopping cart 408 to purchase the selected microservices/microapplications 410.

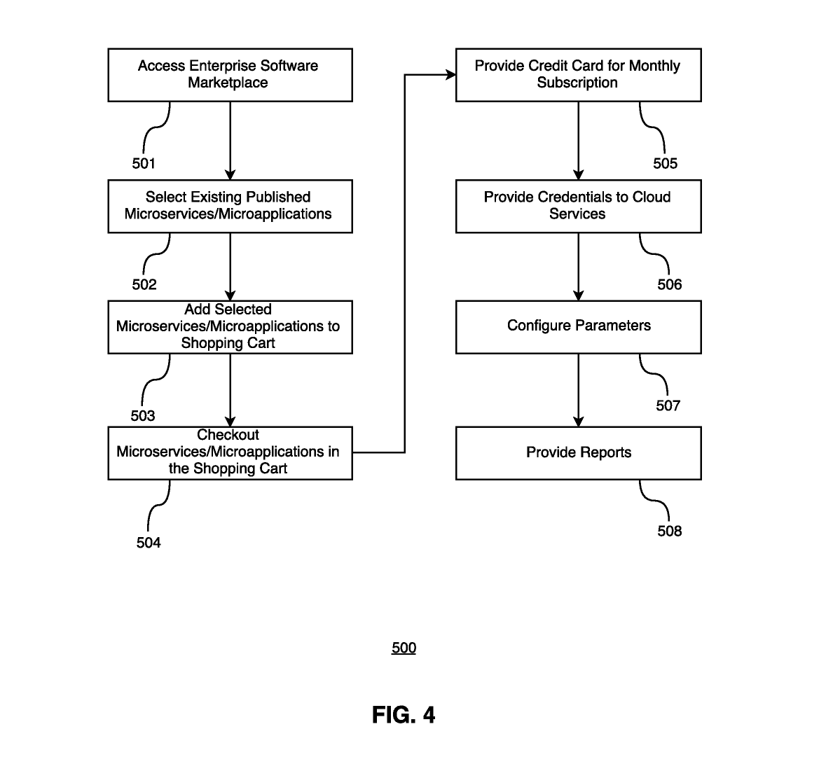

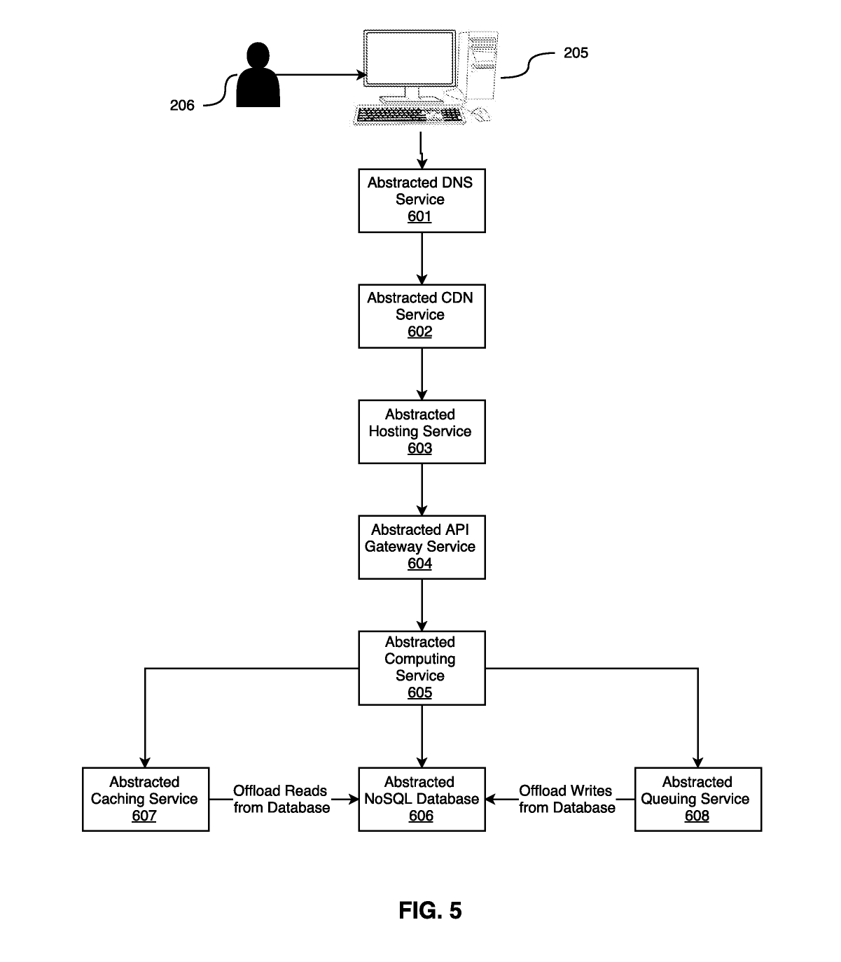

Reference is also made to FIGS. 4 and 5, which schematically illustrate exemplary methods of the present invention. In some embodiments, one or more operations of FIGS. 4 and 5 may be performed by one or more elements of the system, for example, DEEP framework 301 (FIG. 2).

Some embodiments of the present method include subscribing to microservices/microapplications to deploy custom web applications. As indicated in block 501, a customer can access DEEP marketplace 305 (FIG. 2), for example, by accessing a website in a web browser via a user device 205 (FIG. 1) (i.e., a computer system). It is noted that the customer must meet prerequisites in order to build and deploy cloud-native web applications, for example: creating an account at cloud computing providers; configuring the cloud computing providers' command line interface; installing Git; installing JDK and JRE 8, installing nvm and use node v4.3+; and installing DEEP CLI.

The GUI 407 (FIG. 3) of DEEP marketplace 305 (FIG. 2) is configured to display existing published microservices/microapplications 410 (FIG. 3), wherein the microservices/microapplications 410 (FIG. 3) are organized by type (e.g., content management system, data management platform, digital asset management, enterprise content management, serverless web applications, and web content management). As indicated in block 502, a customer can select one or more of the microservices/applications 410 (FIG. 3) and add the selected microservices/microapplications to the shopping cart 503. Once the customer adds all of the desired microservices/microapplications to the shopping cart 408 (FIG. 3), the customer can proceed to checkout, as indicated in block 504.

As indicated in block 505, the GUI 407 of DEEP marketplace 305 (FIG. 2) is configured to obtain a customer's credit card information or other payment information to apply payment for monthly subscription for the microservices/microapplications being purchased. In this regard, the customer's payment information may be automatically derived from the customer's account. Once purchased, the microservices/microapplications may be installed locally and available on a subscription basis.

As indicated in block 506, the GUI 407 of DEEP marketplace then accesses the customer's credentials to the customer's cloud services. Thereafter, the system validates the customer's credentials and the payment information. Once the customer's information is validated, all of the selected microservices/microapplications are combined so as to compile and build front end tier, back end tier, data, and security in the final custom digital system and provision required cloud computing services. The customer can configure parameters 507, and the microservices/microapplications are packaged with customized parameter values. The microservices/microapplications can run in development before deploying the microservices/microapplications via DEEP CLI.

As indicated in block 508, the customer can analyze how DEEP marketplace 305 (FIG. 2) deploys selected code as custom web applications in customer's account, for example, by viewing reports. Optionally, one or more microservices/microapplications 410 (FIG. 3) can be removed from production via DEEP CLI.

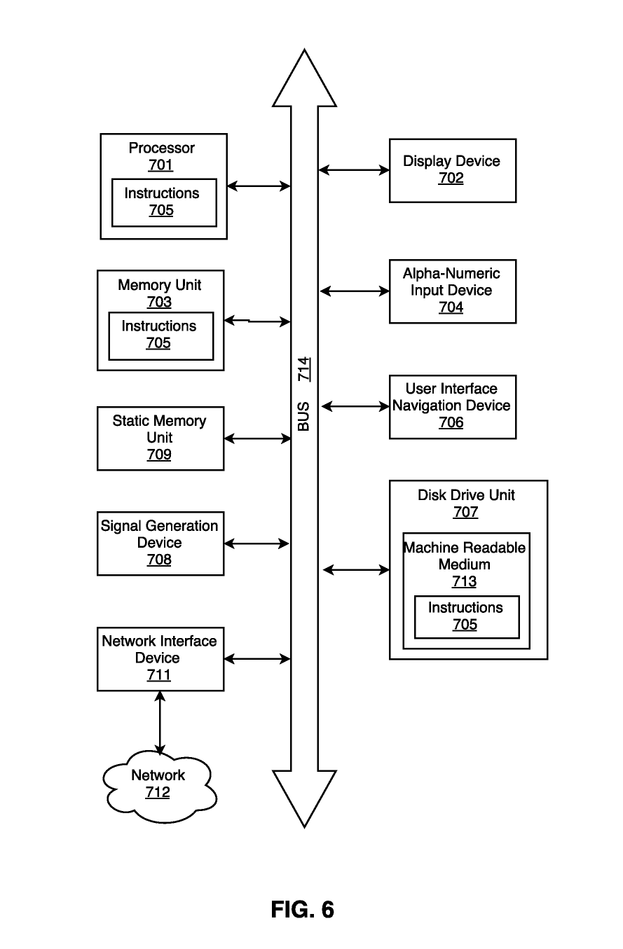

Some embodiments of the present method include building scalable web apps with computing services of a cloud provider and serverless web framework. As shown in FIG. 6, a customer 206 can map domain names to cloud provider service resources, via a user device 205 using abstracted DNS service 601. The method also includes creating abstracted CDN service 602 to distribute globally the front end code and other static assets. Abstracted hosting service 603 is then created to store the front end code and serve it securely to the abstracted CDN service 602.

Abstracted API gateway service 604 is created to expose the computing services functions externally as a RESTful API. Some embodiments further include enabling cross-origin resource sharing (CORS). Abstracted computing service 605 is then created to provide back end code, depending on the use case. Finally, abstracted NoSQL database 606 is created to consistently store the data. Some embodiments include offloading reads from the database via an abstracted caching service 607. Similarly, some embodiments include offloading writes from the database via an abstracted queuing service 608.

Referring now to FIG. 6, is a block diagram of machine in the example form of a computer system within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system includes a processor 701 (e.g., a central processing unit (CPU), a graphics processing unit (GPU)), a main memory unit 703, and a static memory unit 709, which communicate with each other via a bus 714. The computer system may further include a display device 702 (e.g., a liquid crystal display (LCD) or a cathode ray tube (CRT)). The computer system also includes an alphanumeric input device 704 (e.g., a keyboard), a user interface (UI) navigation device 706 (e.g., a mouse), a disk drive unit 707, a signal generation device 708 (e.g., a speaker), and a network interface device 711.

The disk drive unit 707 includes a machine-readable medium 713 on which is stored one or more sets of data structures and instructions 705 (e.g., software) embodying or utilized by any one or more of the methods or functions described herein. The instructions 705 may also reside, completely or at least partially, within the main memory unit 703 and/or within the processor 701 during execution thereof by the computer system. In this regard, the main memory unit 703 and the processor 701 are also considered machine-readable media.

While the machine-readable medium 713 is shown in an example embodiment to be a single medium, the term “machine-readable medium” may include a single medium or multiple media (e.g., a centralized or distributed database, and/or associated caches and servers) that store the one or more instructions 705 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 713 may further be transmitted or received over a computer network 712 using a transmission medium. The instructions 713 may be transmitted using the network interface device 711 and any one of a number of well-known transfer protocols. The term “transmission medium” shall be taken to include any intangible medium that is capable of storing, encoding, or carrying instructions for execution by the machine, and includes digital or analog communications signals or other intangible media to facilitate communication of such software.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A machine-implemented method of managing digital systems, comprising the steps of:
accessing a digital marketplace, wherein said digital marketplace comprises a graphic user interface for displaying a plurality of microservices and microapplications;
adding one or more of said plurality of microservices and microapplications into a shopping cart;
purchasing said one or more of said plurality of microservices and microapplications for subscription;
providing credentials to log onto a cloud provider service;
combining said one or more of said plurality of microservices and microapplications to build a front end tier, a back end tier, data, and security in a final custom digital system and provision required cloud computing services;
configuring parameters to run said one or more of said plurality of microservices and microapplications in a development environment;
packaging said one or more of said plurality of microservices and microapplications with configured parameters; and
deploying said one or more of said plurality of microservices and microapplications as a custom web application in a production environment.

2. The method of claim 1, further comprising the steps of:
removing said one or more of said plurality of microservices and microapplications from said production environment.

3. The method of claim 1, wherein said plurality of microservices and microapplications is associated with a content management system.

4. The method of claim 1, wherein said plurality of microservices and microapplication is associated with a data management platform.

5. The method of claim 1, wherein said plurality of microservices and microapplication is associated with a digital asset management.

6. The method of claim 1, wherein said plurality of microservices and microapplication is associated with an enterprise content management.

7. The method of claim 1, wherein said plurality of microservices and microapplication is associated with serverless web applications.

8. The method of claim 1, wherein said plurality of microservices and microapplication is associated with a web content management.

9. The method of claim 1, further comprising the steps of:
conducting a search for said plurality of microservices and microapplications having a desired functionality; and
selecting one or more of said plurality of microservices and microapplications yielded from said search to add to said shopping cart.

10. A system for managing digital systems, comprising:
a processor and a memory to which said processor is operatively coupled, said memory having executable instructions stored thereon which, when executed, cause said processor to:
access a digital marketplace, wherein said digital marketplace comprises a graphic user interface for displaying a plurality of microservices and microapplications;
add one or more of said plurality of microservices and microapplications into a shopping cart;
purchase said one or more of said plurality of microservices and microapplications for subscription;
provide credentials to log onto a cloud provider service;
combine said one or more of said plurality of microservices and microapplications to build a front end tier, a back end tier, data, and security in a final custom digital system and provision required cloud computing services;
configure parameters to run said one or more of said plurality of microservices and microapplications in a development environment;
package said one or more of said plurality of microservices and microapplications with configured parameters; and
deploy said one or more of said plurality of microservices and microapplications as a custom web application in a production environment.

11. The system of claim 10, wherein said processor is further configured to:
remove said one or more of said plurality of microservices and microapplications from said production environment.

12. The system of claim 10, wherein said plurality of microservices and microapplications is associated with a content management system.

13. The system of claim 10, wherein said plurality of microservices and microapplication is associated with a data management platform.

14. The system of claim 10, wherein said plurality of microservices and microapplication is associated with a digital asset management.

15. The system of claim 10, wherein said plurality of microservices and microapplication is associated with an enterprise content management.

16. The system of claim 10, wherein said plurality of microservices and microapplication is associated with serverless web applications.

17. The system of claim 10, wherein said plurality of microservices and microapplication is associated with a web content management.

18. The system of claim 10, wherein said processor is further configured to:
conduct a search for said plurality of microservices and microapplications having a desired functionality; and
select one or more of said plurality of microservices and microapplications yielded from said search to add to said shopping cart.
